(19) United States
(12) Patent Application Publication
(10) Pub. No.: US 2013/0342423 A1
(43) Pub. Date: Dec. 26, 2013

(54) ELECTRONIC DEVICE, DECORATED ARTICLE, DECORATION FILM, MANUFACTURING METHOD FOR DECORATED ARTICLE AND MANUFACTURING METHOD FOR DECORATION FILM

(71) Applicant: Wei-Hsiang Huang, Taipei City (TW)

(72) Inventor: Wei-Hsiang Huang, Taipei City (TW)

(73) Assignee: Etansi Inc., Taoyuan County (TW)

(21) Appl. No.: 13/530,112

(22) Filed: Jun. 22, 2012

(51) Int. Cl. H01Q 1/40; B05D 5/12; B29C 45/14

(52) U.S. Cl. 343/873; 264/259; 427/58

(57) ABSTRACT

An electronic device, a decorated article, a decoration film, a manufacturing method for the decorated article and a manufacturing method for the decoration film are provided. The decoration film includes a substrate, a releasing layer formed on the substrate, a durable layer formed on the releasing layer, an antenna formed on the durable layer and an adhesive layer covering the durable layer and the antenna. The durable layer has an opening. The antenna covers the opening. The electronic device includes a casing and an electronic module disposed inside the casing. The casing includes a body, an antenna transferred on a surface of the body and a durable layer covering the surface of the body and part of the antenna. The durable layer has an opening, and other part of the antenna is exposed in the opening. The electronic module is electrically connected to the antenna.

### BACKGROUND OF THE INVENTION

1. Field of the Invention

The present invention generally relates to an electronic device with an antenna transferred thereon, a decorated article with an antenna transferred thereon, a decoration film, a manufacturing method for the decorated article and a manufacturing method for the decoration film.

2. Description of Related Art

Following a progress of integrated circuit technology in recent years, wireless communication devices have become lighter, thinner and smaller. Responding to said tendency of the wireless communication devices, antenna integrated on casing for the wireless communication devices are provided. A two-component injection is applied for manufacturing a casing with integrated antenna. In the two-component injection, a main body of the casing is formed by a first injection molding. Thereafter, active metal layer is formed on the main body of the casing by a second injection molding to form a pattern of an antenna. Afterward, the antenna is finished on the active metal layer by wet plating. However, it is difficult to form the active metal layer in correct pattern by the second injection molding, and the molds for the two-component injection are expensive.

Meanwhile, a laser direct structuring is applied for manufacturing a casing with integrated antenna. In the laser direct structuring, the injection material added with photochemical reaction promoter is applied in an injection molding for forming the casing. Thereafter, the casing added with photochemical reaction promoter is radiated by laser. After radiated by laser, the photochemical reaction promoter is transformed into metal grain. That is, a pattern of an antenna constituted with metal grain can be formed on surface of the casing by laser radiation. Afterward, the antenna is finished on the metal grain by wet plating. However, laser radiation is expensive, and the injection material added with photochemical reaction promoter is also expensive. Moreover, whatever the two-component injection or the laser direct structuring, the wet plating for finishing the antenna increases cost and process period, and the wet plating is not friendly to the earth.

### SUMMARY OF THE INVENTION

Accordingly, the present invention is directed to an electronic device having antenna integrated on a casing.

The present invention is directed to a decorated article having antenna integrated thereon.

The present invention is directed to a decoration film having antenna integrated therein.

The present invention is directed to a manufacturing method for a decorated article having antenna integrated thereon.

The present invention is directed to a manufacturing method for a decoration film having antenna integrated therein.

An electronic device of the present invention includes a casing and an electronic module disposed inside the casing. The casing includes a body, an antenna transferred on a surface of the body and a durable layer covering the surface of the body and part of the antenna. The durable layer has an opening, and other part of the antenna is exposed in the opening. The electronic module is electrically connected to the antenna.

In one embodiment of the present invention, the electronic device further includes a conductive pad filled in the opening and electrically connected to the antenna. The electronic module is electrically connected to the antenna through the conductive pad.

In one embodiment of the present invention, the material of the conductive pad is conductive polymer, silver paste or conductive ink

In one embodiment of the present invention, the material of the antenna is copper, silver, gold, aluminium, titanium, indium tin oxide or antimony tin oxide.

A decorated article of the present invention includes an article body, an antenna transferred on a surface of the article body and a durable layer covering the surface of the article body and part of the antenna. The durable layer has an opening, and other part of the antenna is exposed in the opening.

In one embodiment of the present invention, the decorated article further includes a conductive pad filled in the opening and electrically connected to the antenna.

In one embodiment of the present invention, the material of the conductive pad is conductive polymer, silver paste or conductive ink.

In one embodiment of the present invention, the material of the antenna is copper, silver, gold, aluminium, titanium, indium tin oxide or antimony tin oxide.

A decoration film of the present invention includes a substrate, a releasing layer formed on the substrate, a durable layer formed on the releasing layer, an antenna formed on the durable layer and an adhesive layer covering the durable layer and the antenna. The durable layer has an opening. The antenna covers the opening.

In one embodiment of the present invention, the decorated film further includes a conductive pad filled in the opening and electrically connected to the antenna.

In one embodiment of the present invention, the material of the conductive pad is conductive polymer, silver paste or conductive ink.

In one embodiment of the present invention, the material of the antenna is copper, silver, gold, aluminium, titanium, indium tin oxide or antimony tin oxide.

A manufacturing method for a decorated article of the present invention includes following steps. Providing a decoration film including a substrate, a releasing layer formed on the substrate, a durable layer formed on the releasing layer and having an opening, an antenna formed on the durable layer and covering the opening, and an adhesive layer covering the durable layer and the antenna. Feeding the decoration film into a mold with the substrate in contact with an inner surface of the mold. Injecting a plastic material into the mold for forming an article body in the mold. Taking the article body with the decoration film out from the mold. Simultaneously removing both the substrate and the releasing layer.

A manufacturing method for a decoration film of the present invention includes following steps. Forming a releasing layer on a substrate. Forming a durable layer having an opening on the releasing layer. Forming an antenna covering the opening on the durable layer. Forming an adhesive layer which covers the durable layer and the antenna.

In one embodiment of the present invention, the manufacturing method further includes forming a conductive pad filled in the opening and electrically connected to the antenna.

In one embodiment of the present invention, the step of forming the antenna includes: forming a mask layer on the durable layer; forming a conductive layer on the mask layer; and removing the mask layer, so that the antenna is left on the durable layer.

In one embodiment of the present invention, the conductive layer is formed by sputtering, physical vapor deposition or chemical vapor deposition.

As described above, the present invention provides an electronic device, a decorated article, a decoration film, a manufacturing method for the decorated article and a manufacturing method for the decoration film, wherein the antenna can be integrated to an article quickly with lower cost.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A-1F are the cross-section views of a manufacturing method for a decoration film of an embodiment of the present invention.

FIGS. 2A-2D are the cross-section views of a manufacturing method for a decorated article of an embodiment of the present invention.

FIG. 3 is the explode view of an electronic device of an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

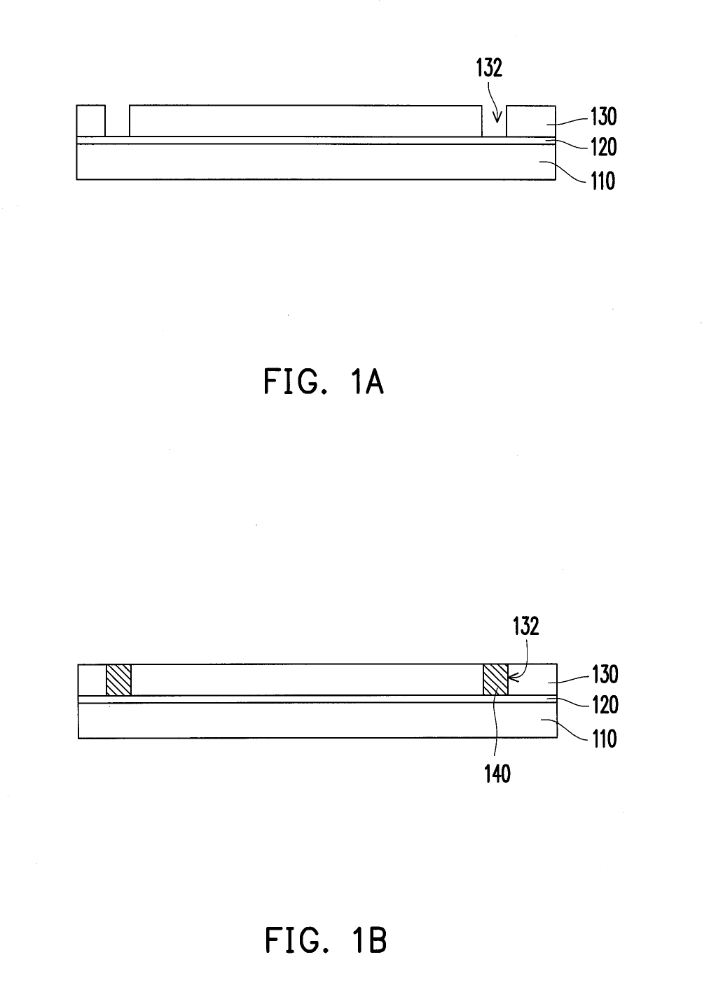

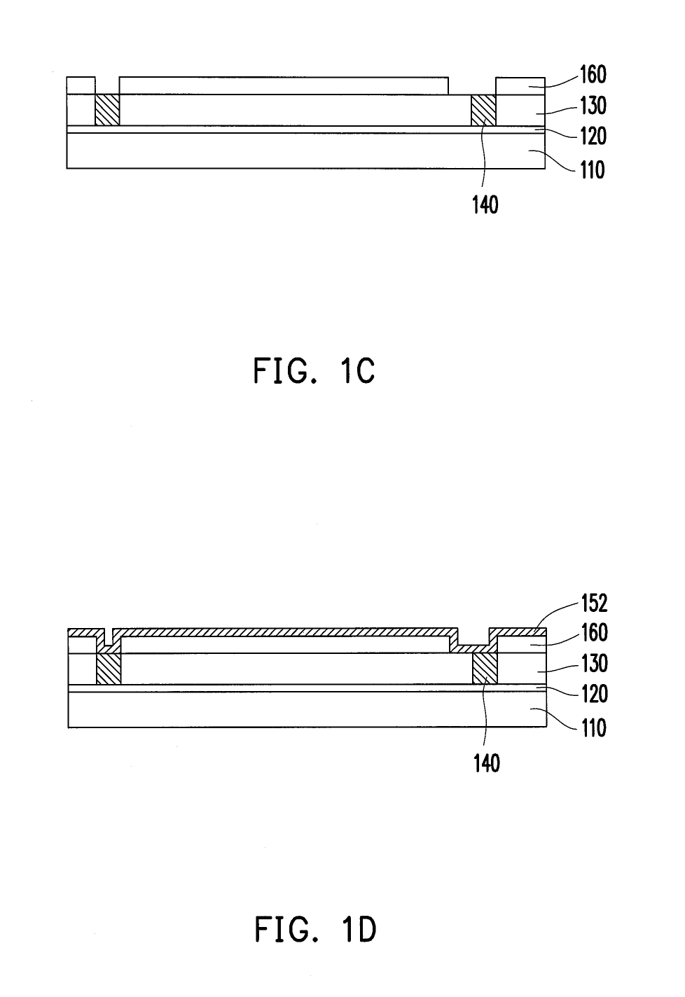

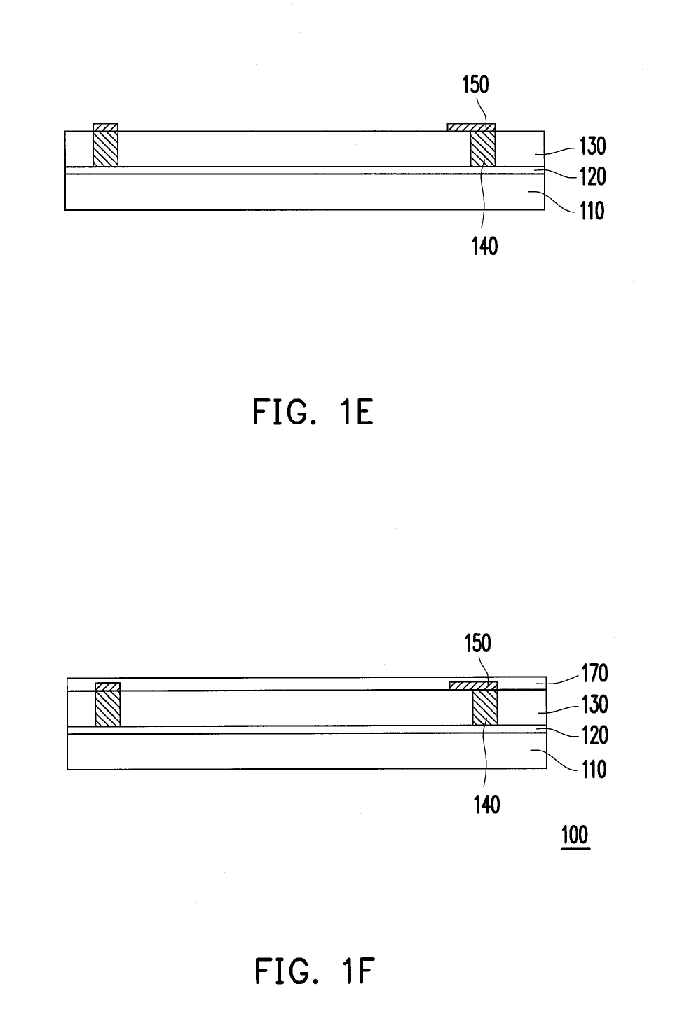

FIGS. 1A-1F are the cross-section views of a manufacturing method for a decoration film of an embodiment of the present invention. Please refer to FIG. 1A, in the manufacturing method for a decoration film of an embodiment of the present invention, a releasing layer 120 is formed on a substrate 110 first. The material of the substrate 110 can be polyethylene terephthalate, polyethylene naphthalate, glycol-polyethylene terephathalate, thermoplastic polyurethane, polyurethane, polypropylene, polycarbonate, amorphous polyethylene terephthalate, polyvinyl chloride, cellulose triacetate, polyamide, styrene-methyl methacrylate copolymer, cyclic olefin copolymer, or a combination of the aforementioned materials. Thereafter, a durable layer 130 having an opening 132 is formed on the releasing layer 120. The material of the durable layer 130 can be radiant curable multifunctional acrylate, epoxide, vinyl ester resin, diallyl phthalate, or vinyl ether, or a combination of the aforementioned materials. Radiant curable multifunctional acrylate can be any one of the following kinds: epoxy acrylate, polyurethane acrylate, polyester acrylate, siloxane acrylate, or glycidyl acrylate. The opening 132 of the durable layer 130 can be formed by stencil printing the durable layer 130 or other suitable method, and the opening 132 can be multiple.

Please refer to FIG. 1B, conductive pads 140 are selectively filled in the openings 132. The quantity of the conductive pads 140 is corresponding to the quantity of the openings 132. The material of the conductive pads 140 is conductive polymer, silver paste or conductive ink

Please refer to FIG. 1E, an antenna 150 is formed for covering the openings 132 on the durable layer. Once the conductive pads 140 are selectively formed, the antenna 150 covers and electrically connects to the conductive pads 140. The material of the antenna 150 can be copper, silver, gold, aluminium, titanium, indium tin oxide or antimony tin oxide.

In the present embodiment, the step of forming the antenna 140 includes following steps. Please refer to FIG. 1C, a mask layer 160 is formed on the durable layer. The mask layer 160 can be formed by stencil printing. Please refer to FIG. 1D, a conductive layer 152 is formed on the mask layer 160. The conductive layer 152 can be formed by sputtering, physical vapor deposition or chemical vapor deposition.

Thereafter, the mask layer 152 is removed, so that the antenna 150 is left on the durable layer 130, as shown in FIG. 1E.

Afterward, an adhesive layer 170 is formed and covers the durable layer 130 and the antenna 150. Briefly, the decoration film 100 of the present embodiment includes a substrate 110, a releasing layer 120 formed on the substrate 110, a durable layer 130 formed on the releasing layer 120, an antenna 150 formed on the durable layer 130 and an adhesive layer 170 covering the durable layer 130 and the antenna 150. The durable layer 130 has an opening 132. The antenna 150 covers the opening 132. A pattern of the antenna 150 can be a design choice for better signal transmitting and receiving ability. Moreover, the decoration film 100 of the present embodiment may further include a conductive pad 140 filled in the opening 132 and electrically connected to the antenna 150.

The antenna 150 formed inside the decoration film 100 can be transferred to a surface of any article quickly and simply. Meanwhile, no chemical for electroplating is necessary to manufacture the decoration film 100, so that the decoration film 100 is friendly to the earth.

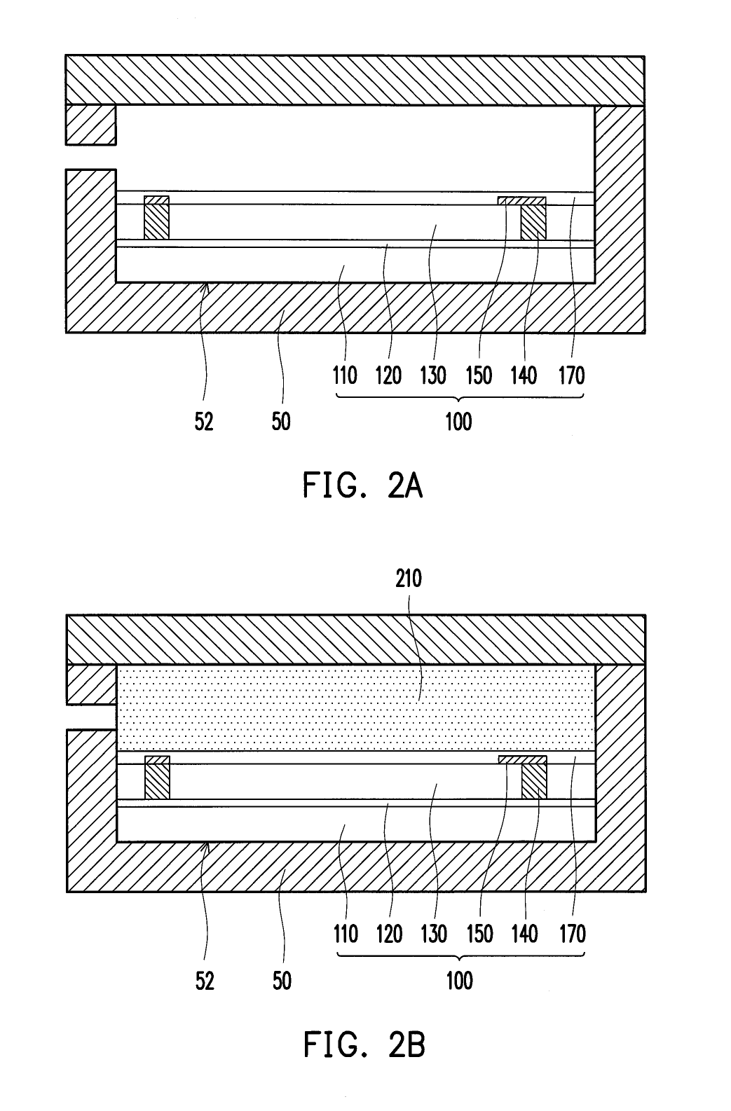

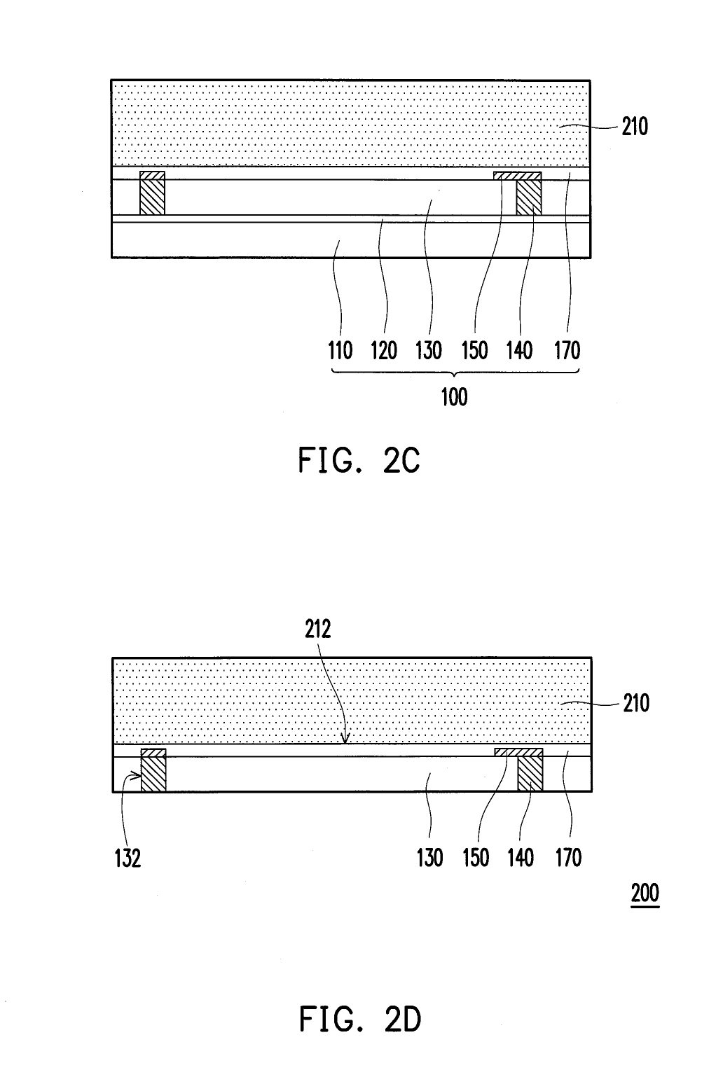

FIGS. 2A-2D are the cross-section views of a manufacturing method for a decorated article of an embodiment of the present invention. Please refer to FIG. 2A, in the manufacturing method for a decorated article of an embodiment of the present invention, a decoration film 100 as shown in FIG. 1E is fed into a mold 50 with the substrate 110 in contact with an inner surface 52 of the mold 50. Please refer to FIG. 2B, a plastic material is injected into the mold 50 for forming an article body 210 in the mold 50. Please refer to FIG. 2C, the article body 210 with the decoration film 100 is took out from the mold 50. Afterward, both the substrate 110 and the releasing layer 120 are simultaneously removed so that the decorated article 200 as shown in FIG. 2D is finished.

Briefly, the decorated article 200 of the present embodiment includes the article body 210, an antenna 150 transferred on a surface 212 of the article body 210, and a durable layer 130 covering the surface of the article body 210 and part of the antenna 150. The durable layer 130 has an opening 132, and other part of the antenna 150 is exposed in the opening 132. The decorated article 210 may further include the conductive pad 140 filled in the opening 132 and electrically connected to the antenna 150. The antenna 150 is transferred to the article body 210 while the article body 210 is formed inside the mold 50. Therefore, the decorated article 200 with integrated antenna 150 can be formed quickly and simply. Meanwhile, no chemical for electroplating is necessary to manufacture the decorated article 200, so that the decorated article 200 is friendly to the earth.

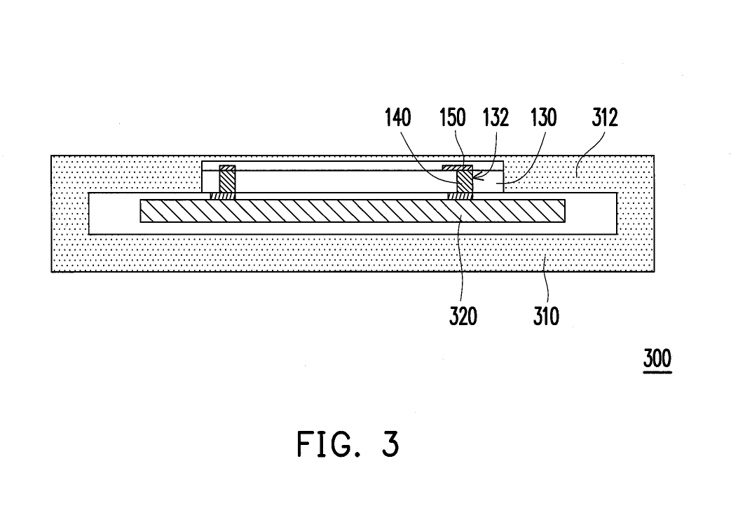

FIG. 3 is the explode view of an electronic device of an embodiment of the present invention. Please refer to FIG. 2A, the electronic device 300 of the embodiment of the present invention includes a casing 310 and an electronic module 320 disposed inside the casing 310. The casing 310 includes a body 312, an antenna 150 transferred on a surface of the body 312 and a durable layer 130 covering the surface of the body 312 and part of the antenna 150. The durable layer 130 has an opening 132, and other part of the antenna 150 is exposed in the opening 132. The electronic module 320 is electrically connected to the antenna 150. In the present embodiment, the electronic module 320 is electrically connected to the antenna 150 through the conductive pad 140. In another embodiment, the electronic module 320 can be directly connected to the antenna 150 in the opening 132. The electronic device 300 with integrated antenna 150 can be formed quickly and simply Meanwhile, no chemical for electroplating is necessary to manufacture the antenna 150 of the electronic device 300, so that the electronic device 300 is friendly to the earth.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electronic device comprising:
a casing comprising:
a body;
an antenna transferred on a surface of the body;
a durable layer covering the surface of the body and part of the antenna, wherein the durable layer has an opening, and other part of the antenna is exposed in the opening; and
an electronic module disposed inside the casing and electrically connected to the antenna.

2. The electronic device according to claim 1, further comprising a conductive pad filled in the opening and electrically connected to the antenna, wherein the electronic module is electrically connected to the antenna through the conductive pad.

3. The electronic device according to claim 2, wherein the material of the conductive pad is conductive polymer, silver paste or conductive ink.

4. The electronic device according to claim 1, wherein the material of the antenna is copper, silver, gold, aluminium, titanium, indium tin oxide or antimony tin oxide.

5. A decorated article comprising:
an article body;
an antenna transferred on a surface of the article body; and
a durable layer covering the surface of the article body and part of the antenna, wherein the durable layer has an opening, and other part of the antenna is exposed in the opening.

6. The decorated article according to claim 5, further comprising a conductive pad filled in the opening and electrically connected to the antenna.

7. The decorated article according to claim 6, wherein the material of the conductive pad is conductive polymer, silver paste or conductive ink.

8. The decorated article according to claim 5, wherein the material of the antenna is copper, silver, gold, aluminium, titanium, indium tin oxide or antimony tin oxide.

9. A decoration film comprising:
a substrate;
a releasing layer formed on the substrate;
a durable layer formed on the releasing layer and having an opening;
an antenna formed on the durable layer and covering the opening; and
an adhesive layer covering the durable layer and the antenna.

10. The decorated film according to claim 9, further comprising a conductive pad filled in the opening and electrically connected to the antenna.

11. The decorated film according to claim 10, wherein the material of the conductive pad is conductive polymer, silver paste or conductive ink.

12. The decorated film according to claim 9, wherein the material of the antenna is copper, silver, gold, aluminium, titanium, indium tin oxide or antimony tin oxide.

13. A manufacturing method for a decorated article comprising:
providing a decoration film comprising:
a substrate;
a releasing layer formed on the substrate;
a durable layer formed on the releasing layer and having an opening;
an antenna formed on the durable layer and covering the opening; and
an adhesive layer covering the durable layer and the antenna;
feeding the decoration film into a mold with the substrate in contact with an inner surface of the mold;
injecting a plastic material into the mold for forming an article body in the mold;
taking the article body with the decoration film out from the mold; and
simultaneously removing both the substrate and the releasing layer.

14. A manufacturing method for a decoration film comprising:
forming a releasing layer on a substrate;
forming a durable layer having an opening on the releasing layer;
forming an antenna covering the opening on the durable layer; and
forming an adhesive layer which covers the durable layer and the antenna.

15. The manufacturing method according to claim 14, further comprising forming a conductive pad filled in the opening and electrically connected to the antenna.

16. The manufacturing method according to claim 14, wherein forming the antenna comprising:
forming a mask layer on the durable layer;
forming a conductive layer on the mask layer; and
removing the mask layer, so that the antenna is left on the durable layer.

17. The manufacturing method according to claim 16, wherein the conductive layer is formed by sputtering, physical vapor deposition or chemical vapor deposition.
